(19) United States
(12) Patent Application Publication
(10) Pub. No.: US 2012/0037185 A1
(43) Pub. Date: Feb. 16, 2012

(54) OPTIMIZATION OF DISH MACHINE PARAMETERS

(75) Inventors: Jeff P. Ellingson, Minnetonka, MN (US); Bryan J. Henneman, Woodbury, MN (US); Andrew M. Jensen, St. Paul, MN (US); Jason A. Kahlhamer, Inver Grove Heights, MN (US)

(73) Assignee: Ecolab USA Inc., St. Paul, MN (US)

(21) Appl. No.: 13/082,558

(22) Filed: Apr. 8, 2011

Related U.S. Application Data
(60) Provisional application No. 61/373,668, filed on Aug. 13, 2010.

(51) Int. Cl. B08B 3/04

(52) U.S. Cl. 134/18; 134/25.2; 134/57 D

(57) ABSTRACT

A dish machine includes optimized dish machine operating parameters that may result in increased energy efficiency and reduced utility costs. The operating parameters may include one or more of a wash water temperature, a rinse water temperature, and/or a rinse flow rate. In some examples, the optimized parameters may include a wash water temperature in the range of 160° F. to 164.5° F., a rinse water temperature in the range of 182° F. and 211° F., and a rinse flow rate in the range of 0.4 gal/rack and of 0.66 gal/rack.

### CROSS REFERENCE TO RELATED APPLICATION

This application claims the benefit of U.S. provisional Application Ser. No. 61/373,668 filed Aug. 13, 2010, the entire contents of which is incorporated herein by reference.

### BACKGROUND

A dish machine is a utility dishwasher used in many restaurants, healthcare facilities, and other locations to clean and sanitize cooking and eating articles, such as dishes, pots, pans, utensils and other cooking equipment. Articles are placed on a rack and provided to a wash chamber of the dish machine. In the chamber, cleaning products and/or rinse agents are applied to the articles during a cleaning process. The cleaning process may include one or more wash phases and one or more rinse phases. At the end of the cleaning process, the rack is removed from the wash chamber so that other racks carrying other articles to be cleaned may be moved into the wash chamber. The cleaning process is then repeated for each of these subsequent racks.

Dish machines that clean and disinfect dishes in industrial settings often consume large amounts of energy and resources to ensure the dishes are cleaned and sanitized to predetermined standards. However, demand for more energy-efficient products that offer savings on energy and other utility bills, without sacrificing performance or features, has been increasing.

### SUMMARY

In general, the disclosure is related to high efficiency dish machines and parameters for operation. The parameters may include, for example, wash water temperature, rinse water temperature, and/or rinse flow rate.

In one example, the disclosure is directed to a method of operating a dish machine, comprising storing a wash water temperature of between 160° F. and 164.5° F., storing a rinse water temperature of between 182° F. and 211° F., storing a rinse flow rate of between 0.4 gal/rack and 0.66 gal/rack, and operating the dish machine at the stored wash water temperature, the stored rinse water temperature, and the stored rinse flow rate. The stored wash water temperature may be approximately 162° F. The stored rinse water temperature may be approximately 187° F. The stored rinse flow rate may be approximately 0.57 gal/rack.

In another example, the disclosure is directed to a dish machine, comprising a wash tank sized to receive articles to be washed, a computer readable medium that stores one or more dish machine operating parameters, wherein the dish machine operating parameters include at least one of a wash water temperature of between 160° F. and 164.5° F., a rinse water temperature of between 182° F. and 211° F., and a rinse flow rate of between 0.4 gal/rack and 0.66 gal/rack, and a processor that controls operation of the dish machine based on the one or more dish machine operating parameters. The dish machine may be a single tank conveyer dish machine. The wash water temperature may be approximately 162° F. The rinse water temperature may be approximately 187° F. The rinse flow rate may be approximately 0.57 gal/rack.

In another example, the disclosure is directed to an apparatus comprising a single wash tank sized to receive articles to be washed during a cleaning process, a conveyor that moves articles through the single wash tank, a dispense module that applies one or more chemical products into the wash tank at appropriate times during the cleaning process, one or more wash arms that deliver water and/or one or more of the chemical products into the wash tank during the cleaning process, a sump positioned to capture and hold liquid drained from the wash tank during the cleaning process, a computer readable medium that stores one or more dish machine operating parameters, wherein the dish machine operating parameters include at least one of a wash water temperature of between 160° F. and 164.5° F., a rinse water temperature of between 182° F. and 211° F., and a rinse flow rate of between 0.4 gal/rack and 0.66 gal/rack, and a dish machine controller that monitors and controls the one or more dish machine operating parameters during the cleaning process.

The details of one or more examples are set forth in the accompanying drawings and the description below. Other features will be apparent from the description and drawings, and from the claims.

### BRIEF DESCRIPTION OF DRAWINGS

FIG. 1 is a cross-sectional view of an example single tank conveyor dish machine.

FIG. 2 is an example graph showing the effect of rinse temp and flow rate at low wash temperature on coated film score.

FIG. 3 is an example graph showing the effect of rinse temp and flow rate at high wash temperature on coated film score.

FIG. 4 is an example graph showing the effect of wash temperature on coated spots score.

FIG. 5 is an example graph showing the effect of wash temperature on redeposit film score.

FIG. 6 is an example graph showing the effect of wash and rinse temperature on redeposit spot score.

FIGS. 7A-7C are graphs showing the effect of example optimized dish machine settings.

FIGS. 8A-8C are graphs showing the effect of example optimized dish machine settings for weighted responses.

FIG. 9 is a block diagram illustrating an example implementation of the electronic components of a dish machine controller.

FIG. 10 is a flow diagram illustrating an example process for setting one or more optimized operational parameters of a dish machine.

FIG. 11 is a flow diagram illustrating an example process for operating a dish machine utilizing one or more optimized operational parameters.

### DETAILED DESCRIPTION

Systems and methods are described that provide optimized operation of a high efficiency dish machine. The dish machines described in this application are generally of the type referred to as a “single tank conveyor” machine. However, it shall be understood that the techniques described herein may also be applied to other types of high efficiency dish machines, such as under counter dish machines, stationary single tank door machines, multiple tank conveyor machines, or other type of dish machine, and that he disclosure is not limited in this respect.

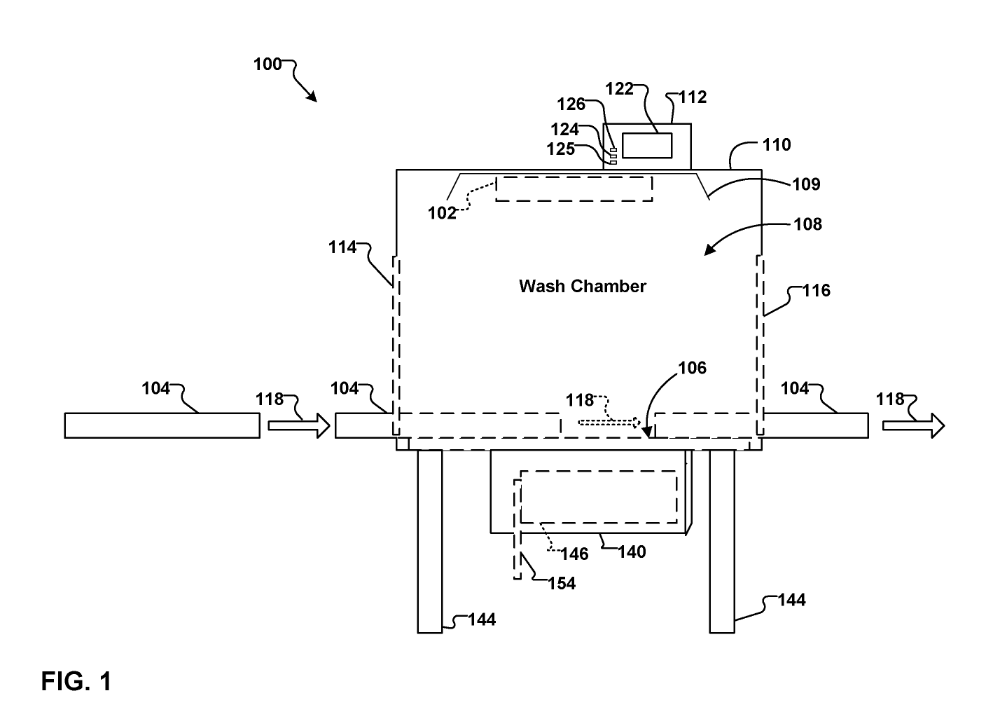

FIG. 1 is a cross-sectional view of an example single tank conveyor dish machine 100. The example dish machine 100 is of the type that is used to clean various dishware and kitchen objects in restaurants, cafeterias, bakeries, and other food service industries. Objects washed by the dish machine 100 are referred to herein as “articles.” The articles are provided to the dish machine 100 on article racks 104.

The dish machine 100 includes a housing 110 defining a wash chamber 108. The housing includes an entry door 114 and an exit door 116. The wash chamber 108 may be supported above ground level by a plurality of legs 144. In operation, each article rack 104 carries one or more articles to be washed by the dish machine 100 into the wash chamber 108 through entry door 114. A conveyor 106 moves the article racks 104 through dish machine 100. Arrows 118 show the direction of article racks 104 through the wash chamber 108 in this example. Article racks 104 leave the dish machine 100 through exit door 116. Entry door 114 and exit door 116 may be uncovered openings, openings covered by curtain-type panels or may be hinged or sliding doors that fully or partially open and close, or other appropriate covering for doors 114 and/or 116.

Dish machine 100 includes a dispense module 102 that dispenses one or more chemical agents, such as one or more cleaning agent(s), one or more rinse agent(s), and/or other chemical products into wash tank 108 at appropriate times during the cleaning process. In this example, dispense module 102 is shown as being located near the top of the inside of the wash chamber 108. However, it shall be understood that dispense module 102 may be located above or below the wash chamber, or at the bottom or side of the wash chamber, and that the disclosure is not limited in this respect.

Dish machine 100 may include one or more sumps 146 positioned underneath the wash chamber 108 in a sump compartment 140. The sump(s) 146 capture and hold liquid drained from the wash chamber 108. A drain 154 is positioned adjacent to the wash sump 146. The height of the drain 154 is less than the height of the wash sump 146 such that the cleaning agent contained in the wash sump 146 overflows into the drain 154. The drain 154 is fluidly connected to a receptacle for communicating fluids to a chemical waste system, such as a septic tank or sewer.

Various operations of the dish machine 100 may be controlled and monitored by a dish machine controller 112. Dish machine controller 112 includes a processor, memory and appropriate programmed software or firmware modules that control and monitor various tasks administered by the dish machine 100 during operation. Dish machine controller monitors and controls dish machine operating parameters, such as wash water temperature, rinse water temperature, and rinse flow rate, during a cleaning process. Dish machine controller 112 may also include various sensors and/or may receive information from various sensors associated with the dish machine. For example, in response to detecting initiation of a wash phase for each rack 104 provided to the dish machine 100, controller 112 may control dispensing of chemical product(s) used during the wash phase(s). Similarly, in response to detecting initiation of a rinse phase, controller 112 may control dispensing of any chemical product(s) used during the rinse phase(s). Controller 112 may also control, for example, the times at which the various wash and/or rinse phases are to occur during a wash cycle; the length of the wash and/or rinse phases; the temperature of the water applied during the wash and/or rinse phases; the times at which chemical products and/or water are dispensed into wash chamber 108 or into sump(s) 146; the concentration of chemical product in the one or more sump(s) 146; periodic emptying of the sump(s) 146; operation of one or more wash arms 109 or other mechanism through which water and/or chemical product(s) are dispensed into the wash chamber or into sump(s) 146; operation of a conveyor; and any other processes in the wash machine that may be electronically controlled.

Dish machine 100 may include one or more display devices or modules, such as, first, second and third status indicators 124, 125 and 126, e.g., light emitting diodes (LED's), and/or a graphical user interface 122, for example. Interface 122 may be used to input commands into the controller 112. Interface 122 provides a computer-assisted means through which operators can set up and deploy the dish machine 100 into operation in an intended service environment, such as, for example, a restaurant, a hotel, etc.. It should be appreciated that any conventional interface (e.g., touch-screen interfaces, mouse-based interfaces, keyboard-based interfaces, etc.) may be used, and that the disclosure is not limited in this respect. Furthermore, the GUI 122 and the first, second and third status indicators 124, 125 and 126 may provide operators with functionality to monitor operation of the dish machine 100 by displaying information relating to the various tasks that are controlled and monitored by the controller 112.

For example, the first, second and third status indicators 124, 125 and 126 may indicate the current operational status of the dish machine 100 (e.g., wash phase, rinse phase, final rinse phase, etc.). However, it shall be appreciated that more or fewer status indicators, or other types of indicators, such as audible or visual alerts, may be used for any other purpose related to operation of the dish machine 100.

Controller 112 may also store optimized dish machine operating parameters that may result in increased energy efficiency and reduced utility costs. A dish machine 100 using such optimized dish machine parameters may meet the definition of a “high efficiency” dish machine. In general, the term “high efficiency” dish machine as used herein means a dish machine that meets the specifications required to achieve ENERGY STAR status. ENERGY STAR is a joint program of the U.S. Environmental Protection Agency (EPA) and the U.S. Department of Energy. Products can earn the ENERGY STAR label by meeting the energy efficiency requirements set forth in ENERGY STAR product specifications established by the EPA. These specifications may be revised from time to time. Currently, the requirements to achieve ENERGY STAR status for a single tank conveyor machine are shown in Table 1.

TABLE 1
Requirements to Achieve Energy Star
Status (Single Tank Conveyor)

| High Temp | | Low Temp | |
|---|---|---|---|
| Efficiency Requirements | | Efficiency Requirements | |
| Idle Energy | Water | Idle Energy | Water |
| Rate* | Consumption | Rate* | Consumption |
| ≦2.0 kW | ≦0.7000 gal/rack | ≦1.6 kW | ≦0.790 gal/rack |

*Idle energy rate as measured with door closed and rounded to 2 significant digits.

The optimized dish machine operating parameters may include, for example, a wash water temperature (or “wash temperature”), a rinse water temperature (or “rinse temperature), and a rinse flow rate. Operation of a single tank conveyor machine, such as machine 100 shown in FIG. 1, under these optimized parameters may result in increased energy efficiency and reduced utility costs, while still maintaining desired cleaning performance.

For example, experiments (described below) indicate that the optimized parameters for a single tank conveyor type dish machine (such as that shown in FIG. 1) may include a wash water temperature in the range of 160° F. to 164.5° F., a rinse water temperature in the range of 182° F. and 211° F., and a rinse flow rate in the range of 0.4 gal/rack and of 0.66 gal/rack. In a more specific example, the optimized parameters may include a wash water temperature of approximately 160° F., a rinse water temperature of approximately 187° F., and a rinse flow rate of approximately 0.57 gal/rack. As described below, tests indicated that a good result occurred at this relatively low flow rate (e.g., 0.57 gal/rack) but also that better results were produced at this low flow rate than results at higher flow rates with all other conditions being the same.

A series of experiments were designed to investigate and optimize three dish machine design parameters: wash water temperature, rinse water temperature, and rinse flow rate to achieve superior results at a set food soil and detergent concentration. The tests were executed as a designed experiment with three factors (wash water temperature, rinse water temperature, and rinse flow rate) and two levels (high and low). The levels for each factor are given in Table 2.

TABLE 2
Design Factors and Levels

| Factor | High Level | Low Level |
|---|---|---|
| Wash Temperature | 172° F. | 160° F. |
| Rinse Temperature | 187° F. | 180° F. |
| Rinse Flow Rate | 0.67 gal/rack | 0.57 gal/rack |
| | (2.22 gal/min) | (1.90 gal/min) |

In this example and as described below, the overall results of the experiments showed the dish machine parameters that achieved the best cleaning performance include a wash water temperature of approximately 160°, a rinse water temperature of approximately 187° F., and a rinse flow rate of approximately 0.57 gal/rack. Follow up testing revealed that further increasing of the rinse water temperature improved results when a higher food soil concentration (4500 ppm) was present in the wash tank, but did not improve results at lower food soil concentrations (2000 ppm).

### Experiments

Glasses were tested to determine the impact of wash water temperature, rinse water temperature, and rinse flow rate. The glasses were prepared by first cleaning them. During the test, a concentration of 1200 ppm (8 T1 drops) detergent and a concentration of 2000 ppm food soil (⅔ beef stew, ⅓ potato buds) was maintained in the wash tank throughout the test. The results were analyzed by visual grading of coated (dipped in whole milk and allowed to dry) and redeposit (not coated) glasses. For the actual test, the glasses were run for one wash cycle. Following the wash cycle, the glasses that had been dipped in whole milk were redipped and allowed to dry and then returned to the dish machine and all glasses were then sent through the wash cycle again. This was repeated until a number of cycles were run. After a number of cycles, the wash water was retested to make sure the proper level of detergent was present. Then the entire process was repeated. The glasses were allowed to dry overnight and then visually graded for film accumulation and spotting. The film accumulation was caused by the presence of milk fat residue on the glasses and redeposition of the food soil on the glasses.

The glasses were given a film and spot score ranging from 1-5 (1 being the best score and 5 being the worst score). The average of the scores were compiled for each run. In general, relatively better cleaning performance is indicated by a relatively lower Total Score. Table 3 shows the test parameters and average score data for each run.

TABLE 3
Experimental Results

| | | | | Coated | Coated | Redeposit | Redeposit | |
|---|---|---|---|---|---|---|---|---|
| | Flow | Wash | Rinse | Film | Spots | Film | Spots | |
| | Rate | Temp | Temp | Score | Score | Score | Score | Total |
| Run | (gal/rack) | (deg F.) | (deg F.) | (1-5) | (1-5) | (1-5) | (1-5) | Score |
| 1 | 0.57 | 172 | 180 | 2.25 | 3.75 | 1.5 | 3.92 | 14.92 |
| 2 | 0.57 | 160 | 187 | 2 | 2.58 | 1.5 | 3 | 12.58 |
| 5 | 0.57 | 160 | 180 | 3.92 | 2.92 | 2 | 5 | 17.34 |
| 8 | 0.57 | 172 | 187 | 2.08 | 3.92 | 1.5 | 4 | 15 |
| 10 | 0.57 | 172 | 180 | 2.42 | 3.92 | 1.75 | 3.42 | 15.01 |
| 12 | 0.57 | 160 | 180 | 2.4 | 3.33 | 2.5 | 3 | 14.73 |
| 14 | 0.57 | 172 | 187 | 2 | 3.75 | 1.5 | 4.08 | 14.83 |
| 16 | 0.57 | 160 | 187 | 2 | 2.5 | 1.58 | 2.285 | 11.865 |
| 3 | 0.67 | 172 | 180 | 2.25 | 4.5 | 2 | 3.5 | 15.75 |
| 4 | 0.67 | 160 | 187 | 2.83 | 2.58 | 2.5 | 2.91 | 14.32 |
| 6 | 0.67 | 172 | 180 | 2 | 3.58 | 1.5 | 3.33 | 13.91 |
| 7 | 0.67 | 160 | 180 | 2.48 | 2.71 | 2.87 | 3.57 | 15.13 |
| 9 | 0.67 | 160 | 187 | 3.42 | 2.5 | 3.42 | 1.58 | 14.42 |
| 11 | 0.67 | 172 | 187 | 2.5 | 4.25 | 1.5 | 3.75 | 15.5 |
| 13 | 0.67 | 172 | 187 | 3.92 | 3.92 | 1.5 | 3.83 | 16.67 |
| 15 | 0.67 | 160 | 180 | 2.83 | 3.75 | 1.7 | 3.6 | 15.38 |

Coated Film—Low Rinse Water temperature

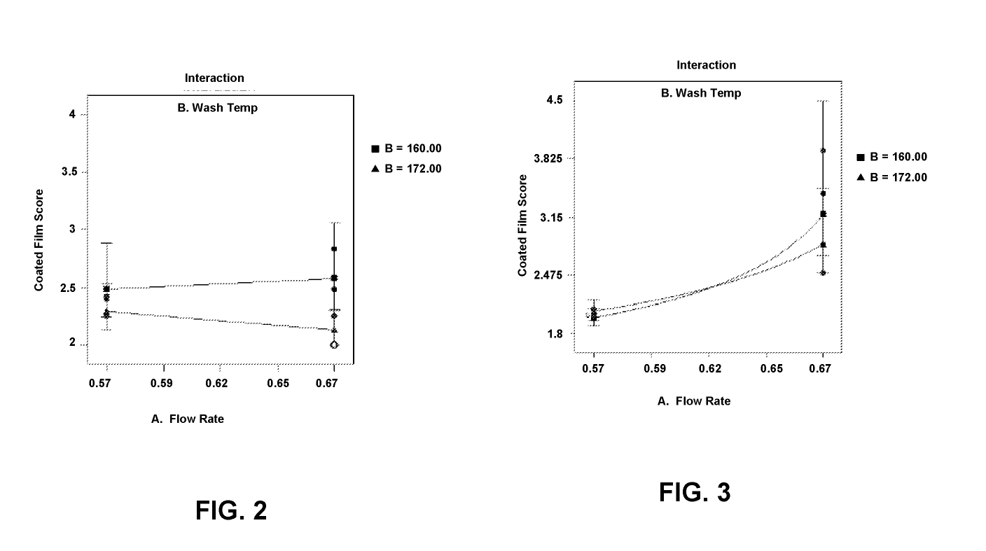

FIG. 2 illustrates the effect of rinse water temp and rinse flow rate at low wash water temperature on coated film score. In particular, FIG. 2 shows that at a low rinse water temperature (180° F. in this example) the film score on the coated glasses are nearly identical for high (172° F. in this example) and low (160° F. in this example) wash water temperatures at both high (0.67 gal/rack) and low (0.57 gal/rack) rinse flow rates. This is evinced by the overlap of the 95% confidence intervals at each point. FIG. 2 also shows that the system is very robust to changes in wash water temperature and flow rate when using a low rinse water temperature. The R² value is 0.8609 and the predicted R² value is 0.5048. The R² value is relatively good considering the subjective nature of the film and spot score system. The predicted R² value demonstrates that this model can explain the behavior of the system 50% of the time better than random guessing.

### Coated Film—High Rinse Water Temperature

FIG. 3 illustrates the effect of rinse water temp and rinse flow rate at high wash water temperature on coated film score. In particular, FIG. 3 shows that at high rinse water temperature (187° F. in this example), there is a much stronger influence of rinse flow rate on the coated glass film score. At low rinse flow rates (0.57 gal/rack in this example), the coated glass film score is nearly identical for both high (172° F. in this example) and low (160° F. in this example) wash water temperature. The film score on the coated glass increased (that is, cleaning performance decreased) with increasing rinse flow rate. The two wash water temperatures (172° F. and 160° F. in this example) are not statistically distinguishable at high rinse flow rate, but both results were worse than at low rinse flow rate. This leads to the conclusion, in this example, that the performance with regard to the film score on the coated glass may be optimized by decreasing rinse flow rate to 0.57 gal/rack. The high wash water temperature gives a slightly more robust system with regards to coated film formation. This conclusion can be inferred because the change in performance is affected less by rinse flow rate at high wash water temperature than low wash water temperature. Since this result was generated using the same model as the previous section, the R² value is the same as well.

### Coated Spots—Effect of Wash Temperature on Coated Spots Score

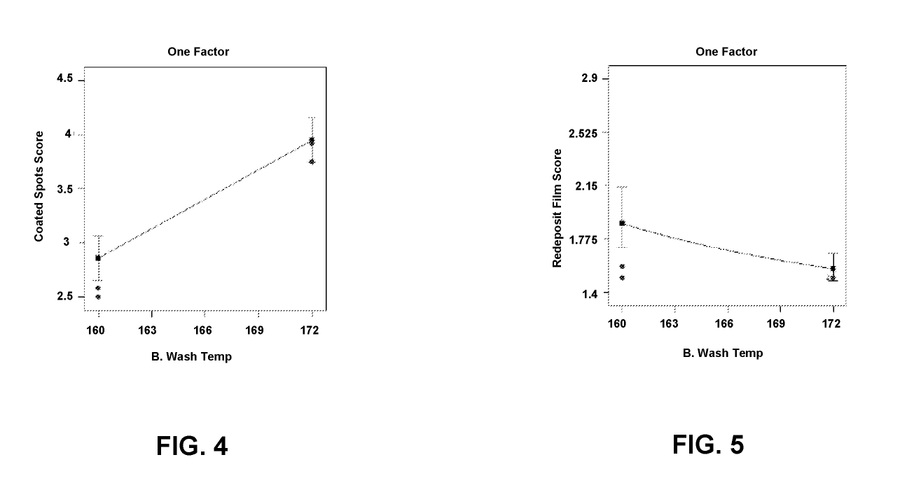

FIG. 4 illustrates that the spot score on the coated glass increased at a high wash water temperature (172° F. in this example) as compared to a lower wash water temperature (160° F. in this example). That is, cleaning performance decreased with increasing wash water temperature. This effect was independent of rinse water temperature (187° F. in this example) and rinse flow rate (0.57 gal/rack in this example). This leads to the conclusion that the performance with regard to the spot score on the coated glass may be improved by decreasing the wash water temperature to 160° F. The R² value is 0.6969 and the predicted R² value is 0.6041. This means that the model explains the behavior of this system 60% of the time.

### Redeposit Film—Effect of Wash Temperature on Redeposit Film Score

FIG. 5 illustrates that increasing wash water temperature slightly decreases the redeposit film score. That is, cleaning performance was somewhat improved at a relatively higher wash water temperature (172° F. in this example) as compared to a relatively lower wash water temperature (160° F. in this example). The 95% confidence intervals may overlap slightly so the difference in performance at high and low wash water temperatures may not be entirely statistically distinct. This effect was also independent of rinse water temperature (187° F. in this example) and rinse flow rate (0.57 gal/rack in this example). This leads to the conclusion that the film score on the redeposit glass may be improved by increasing wash water temperature to 172° F. The R² value is 0.3312 and the predicted R² value is 0.1020.

### Redeposit Spots—Effect of Wash and Rinse Temperature on Redeposit Spot Score

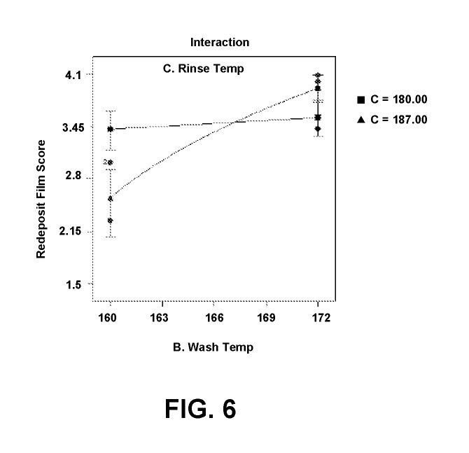

FIG. 6 shows that increasing wash water temperature (172° F. as compared to 160° F.) has no effect on the formation of spots on the redeposit glasses because there is enough overlap of the interval plots to be able to conclude that it is not likely statistically distinguishable. This indicates that the system is robust to changes in wash water temperature at low rinse water temperature (180° F. in this example). At high rinse water temperature (187° F. in this example), the results improved with decreasing wash water temperature. This plot also shows that at low wash water temperature, redeposit spot results are better at higher rinse water temperature. The intervals on the right side of FIG. 6 just barely overlap, suggesting that it is likely statistically distinguishable results. All of the preceding results are independent of rinse flow rate. This leads to the conclusion that the spot score on the redeposit glass can be improved by increasing the rinse water temperature to 187° F. and decreasing the wash water temperature to 160° F. The R² value is 0.7833 and the predicted R² value is 0.5914. Again, this is a fairly good predicted R² value because it shows that the model explains the behavior of this system 59% of the time.

### Optimization

Based on the experimental results discussed above, optimized wash water temperature, rinse water temperature, and rinse flow rate may be determined. For example, a desirability score (right-most column of Table 4, below) may be used to indicate how near the desired output (that is minimized spot and film scores indicative of relatively better cleaning performance) the conditions are predicted to achieve. In this example, the desirability score is scaled from 0 to 1. In general, the nearer the desirability score is to 1, the better the conditions are able to produce the desired results (minimized film and spot scores).

TABLE 4

| | Flow | Wash | Rinse | Coated | Coated | Redeposit | Redeposit | |
|---|---|---|---|---|---|---|---|---|
| Number | Rate | Temp | Temp | Film | Spots | Film | Spots | Desirability |
| 1 | 0.57 | 160 | 187 | 1.98 | 2.86 | 1.88 | 2.57 | 0.73 |
| 2 | 0.57 | 160 | 187 | 2.00 | 2.86 | 1.88 | 2.57 | 0.73 |
| 3 | 0.57 | 160 | 187 | 1.99 | 2.86 | 1.88 | 2.57 | 0.73 |
| 4 | 0.57 | 160 | 187 | 2.00 | 2.86 | 1.88 | 2.57 | 0.73 |
| 5 | 0.57 | 160 | 187 | 1.98 | 2.86 | 1.88 | 2.57 | 0.73 |
| 6 | 0.57 | 160.12 | 187 | 1.98 | 2.87 | 1.88 | 2.59 | 0.72 |
| 7 | 0.57 | 160.25 | 187 | 1.98 | 2.88 | 1.87 | 2.61 | 0.72 |
| 8 | 0.57 | 160 | 186.76 | 2.00 | 2.86 | 1.88 | 2.60 | 0.72 |
| 9 | 0.57 | 160.59 | 186.68 | 2.00 | 2.91 | 1.86 | 2.71 | 0.72 |
| 10 | 0.57 | 162.85 | 186.97 | 2.00 | 3.12 | 1.78 | 3.01 | 0.69 |
| 11 | 0.67 | 167.06 | 180 | 2.28 | 3.50 | 1.67 | 3.50 | 0.54 |
| 12 | 0.67 | 167.01 | 180 | 2.28 | 3.50 | 1.67 | 3.50 | 0.54 |
| 13 | 0.67 | 167.13 | 180 | 2.28 | 3.51 | 1.67 | 3.50 | 0.54 |
| 14 | 0.67 | 166.75 | 180 | 2.29 | 3.47 | 1.68 | 3.50 | 0.54 |
| 15 | 0.67 | 166.93 | 180 | 2.28 | 3.49 | 1.67 | 3.50 | 0.54 |
| 16 | 0.67 | 167.64 | 180 | 2.26 | 3.55 | 1.65 | 3.51 | 0.54 |

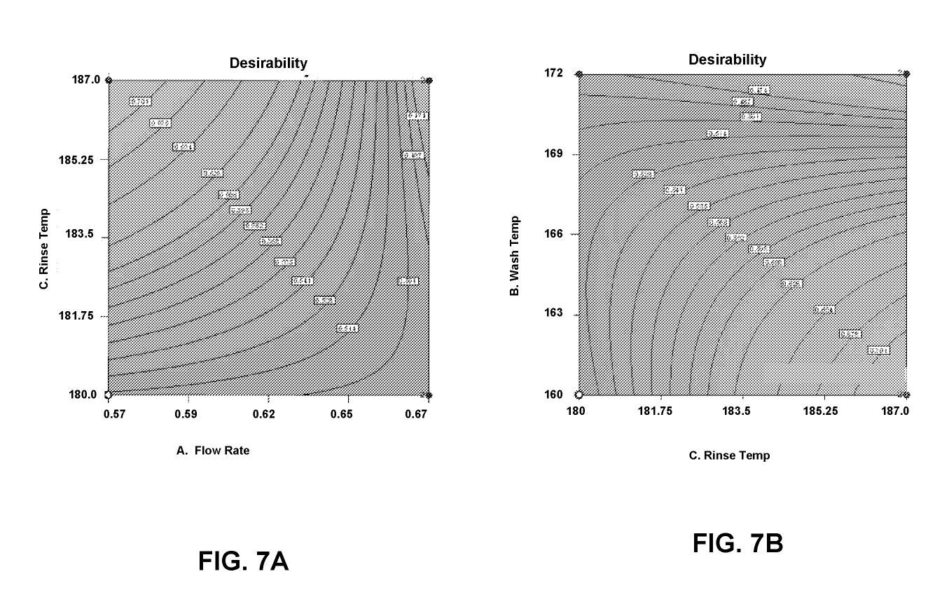

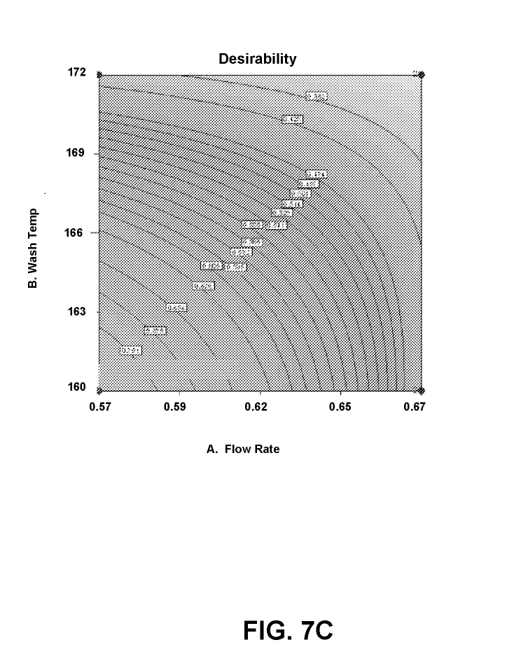

FIGS. 7A-7C are graphs showing the effect of changing wash water temperature, rinse water temperature, and/or rinse flow rate on desirability score. In FIGS. 7A-7C, desirability is on the z axis, and is indicated by the contours. More specifically, FIG. 7A is a graph of rinse temperature (y-axis) versus rinse flow rate (x-axis) at a constant wash temperature of 160° F. In FIG. 7A, moving towards the top left corner of the plot (relatively higher rinse temperature, relatively lower rinse flow rate) increases the desirability. FIG. 7B is a graph of wash temperature (y-axis) versus rinse temperature (x-axis) at a constant rinse flow rate of 0.57 gal/rack. In FIG. 7B, moving toward the lower right corner (high rinse temperature, low wash temperature) increases the desirability. FIG. 7C is a graph of wash temperature (y-axis) versus rinse flow rate (x-axis) at a constant rinse temperature of 187° F. In FIG. 7C, moving toward the lower left corner (relatively lower flow rate, relatively lower wash temperature) increases results.

In another example, the dish machine parameters may be optimized by weighting the film, spot, and redeposit scores, indicating a degree of importance for each response. For example, by giving spots an importance of 5 (highest importance), film scores an importance of 1 (lowest importance), and Total (the sum of all the average scores) an importance of 3 (medium importance), the optimized dish machine settings shown in Table 5 were generated.

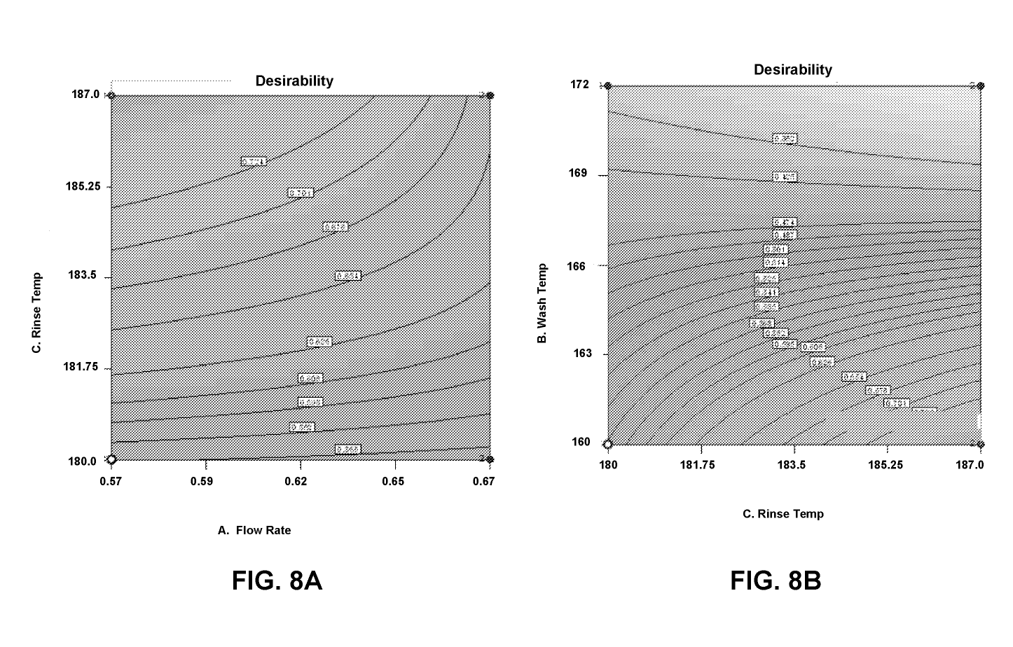

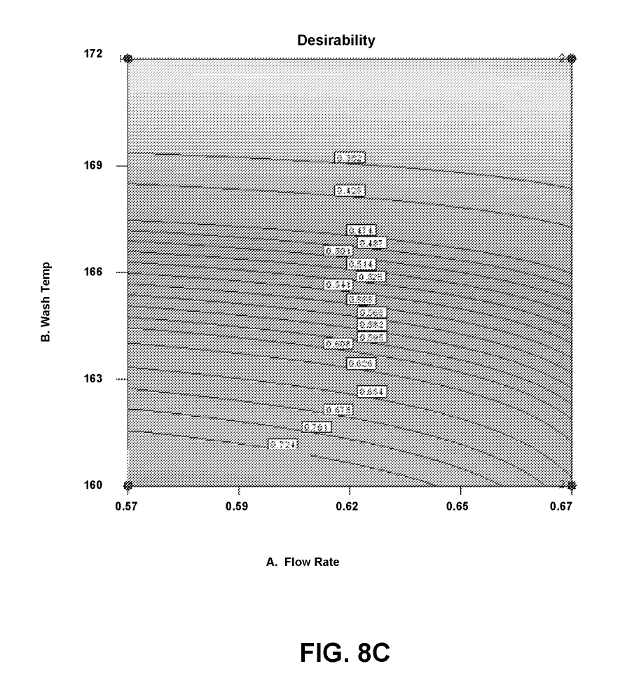

FIGS. 8A-8C are graphs showing the effect of example optimized dish machine settings for the weighted responses of Table 5. The conditions of FIGS. 8A-8C correspond to those shown in FIGS. 7A-7C, respectively. The results of the analysis with the weighted responses generated nearly the same general results as those shown in FIGS. 7A-7C; namely, that the wash temperature should be low, the rinse temperature should be high, and the rinse flow rate low. The desirability increased a bit, indicating that it is more likely to achieve the desired weighted results with the conditions chosen.

TABLE 5
Optimal Dish machine Settings for weighted responses

| | Flow | Wash | Rinse | Coated | Coated | Redeposit | Redeposit | |
|---|---|---|---|---|---|---|---|---|
| Number | Rate | Temp | Temp | Film | Spots | Film | Spots | Desirability |
| 1 | 0.57 | 160 | 187 | 1.98 | 2.86 | 1.88 | 2.57 | 0.78 |
| 2 | 0.57 | 160 | 187 | 1.99 | 2.86 | 1.88 | 2.57 | 0.78 |
| 3 | 0.57 | 160 | 187 | 2.00 | 2.86 | 1.88 | 2.57 | 0.78 |
| 4 | 0.57 | 160 | 187 | 1.99 | 2.86 | 1.88 | 2.57 | 0.78 |
| 5 | 0.57 | 160 | 186.97 | 2.00 | 2.86 | 1.88 | 2.57 | 0.78 |
| 6 | 0.58 | 160 | 187 | 2.01 | 2.86 | 1.88 | 2.57 | 0.78 |
| 7 | 0.57 | 160 | 186.89 | 1.99 | 2.86 | 1.88 | 2.58 | 0.78 |
| 8 | 0.58 | 160 | 187 | 2.03 | 2.86 | 1.88 | 2.57 | 0.78 |
| 9 | 0.58 | 160 | 187 | 2.04 | 2.86 | 1.88 | 2.57 | 0.78 |
| 10 | 0.57 | 160.13 | 187 | 2.00 | 2.87 | 1.88 | 2.59 | 0.78 |
| 11 | 0.59 | 160 | 187 | 2.08 | 2.86 | 1.88 | 2.57 | 0.77 |
| 12 | 0.57 | 160 | 186.59 | 2.00 | 2.86 | 1.88 | 2.63 | 0.77 |
| 13 | 0.57 | 160.03 | 186.61 | 2.00 | 2.86 | 1.88 | 2.63 | 0.77 |
| 14 | 0.57 | 160 | 186.55 | 2.00 | 2.86 | 1.88 | 2.64 | 0.77 |
| 15 | 0.57 | 160 | 186.51 | 2.01 | 2.86 | 1.88 | 2.64 | 0.77 |
| 16 | 0.59 | 160 | 187 | 2.10 | 2.86 | 1.88 | 2.57 | 0.77 |
| 17 | 0.59 | 160 | 187 | 2.11 | 2.86 | 1.88 | 2.57 | 0.77 |
| 18 | 0.6 | 160 | 187 | 2.13 | 2.86 | 1.88 | 2.57 | 0.77 |
| 19 | 0.6 | 160 | 187 | 2.13 | 2.86 | 1.88 | 2.57 | 0.77 |
| 20 | 0.57 | 160 | 186.36 | 2.01 | 2.86 | 1.88 | 2.67 | 0.77 |
| 21 | 0.6 | 160 | 187 | 2.17 | 2.86 | 1.88 | 2.57 | 0.76 |
| 22 | 0.6 | 160 | 187 | 2.19 | 2.86 | 1.88 | 2.57 | 0.76 |
| 23 | 0.62 | 160 | 187 | 2.30 | 2.86 | 1.88 | 2.57 | 0.75 |
| 24 | 0.62 | 160 | 187 | 2.35 | 2.86 | 1.88 | 2.57 | 0.74 |
| 25 | 0.63 | 160 | 187 | 2.45 | 2.86 | 1.88 | 2.57 | 0.73 |
| 26 | 0.63 | 160 | 187 | 2.47 | 2.86 | 1.88 | 2.57 | 0.73 |
| 27 | 0.64 | 160 | 187 | 2.52 | 2.86 | 1.88 | 2.57 | 0.73 |
| 28 | 0.65 | 160 | 186.87 | 2.74 | 2.86 | 1.88 | 2.59 | 0.70 |

In general, these tests determined that optimized parameters for operating a single tank conveyor type dish machine may include a wash temperature of 160° F., a rinse temperature of 187° F., and a rinse flow rate of 0.57 gal/rack.

### Additional Experiments

Two additional experiments were run to follow up and confirm the results of the designed experiment described above. The first follow up experiment was a ten cycle using the example optimized wash temperature (160° F.) and rinse flow rate (0.57 gal/rack) with an increased rinse temperature of 195° F. The second follow up experiment was a ten cycle using the example optimized wash and rinse temperatures (160° F. and 187° F., respectively) with a decreased rinse flow rate of 0.5 gal/rack. The test conditions for the first experiment were 1200 ppm of detergent and 2000 ppm of food soil. The first follow up experiment was then repeated with higher food soil concentration (4500 ppm). The conditions for the second follow up experiment were 2550 ppm and 4500 ppm food soils. The results of these experiments are summarized in Table 6, along with the baseline experiments for comparison. The sum of the averages in the following table is the average total score of two runs.

TABLE 6
Follow up test results

| Food Soil | Detergent | Wash | Rinse | Rinse | |
|---|---|---|---|---|---|
| Concen- | Concen- | Temper- | Temper- | Flow | |
| tration | tration | ature | ature | Rate | Sum of |
| (ppm) | (ppm) | (° F.) | (° F.) | (gal/rack) | Averages |
| 2000 | 1200 | 160 | 187 | 0.57 | 12.605 |
| 2000 | 1200 | 160 | 195 | 0.57 | 14.08 |
| 4500 | 1200 | 160 | 187 | 0.57 | 15.62 |
| 4500 | 1200 | 160 | 195 | 0.57 | 14.5 |
| 4500 | 2550 | 160 | 187 | 0.57 | 12.17 |
| 4500 | 2550 | 160 | 187 | 0.5 | 10.85 |

In this example, the results of the follow up testing revealed that increasing the temperature of the rinse beyond 187° F. did not improve performance when using lower food soil concentration. However, it did improve performance when the food soil concentration was increased.

Additionally, the results of the follow up testing showed that further lowering of the rinse flow rate improved ten cycle test results. One possible explanation for this result is that the lower rinse flow rate may have left more residual detergent on the glassware, which may have reduced spotting due to the residual surfactant. Follow up tests on the detergent carryover were run, but did not appear to reveal any more detergent carryover than was seen with the 0.57 gal/rack flow rate. This study suggests that optimized parameters for a single tank conveyor type dish machine (such as that shown in FIG. 1) may include a wash temperature of 160° F., a rinse temperature of 187° F., and a rinse flow rate of 0.5 gal/rack.

In another example, optimized ranges for one or more of the operating parameters (wash water temperature, rinse water temperature, and/or rinse flow rate) may be determined. For example, optimized ranges (listed below in Table 7) for each of the three operating parameters (wash water temperature, rinse water temperature, and rinse flow rate) were compiled using a statistical model based on the designed experiments discussed above. In this example, the model predicted the results based on all the input variables. The model was reiterated until a decrease in performance by 10% was reached (so essentially, at the maximum and minimum in Table 6 the results will be 10% worse than the optimal conditions.

TABLE 7
Parameters and Ranges

| | Optimized | | |
|---|---|---|---|
| Factor | Conditions | Minimum | Maximum |
| Wash Temperature | 162° F. | 160° F. | 164.5° F. |
| Rinse Temperature | 187° F. | 182° F. | 211° F. |
| Rinse Flow Rate | 0.57 gal/rack | 0.4 gal/rack | 0.66 gal/rack |

The data of Table 7 indicates that optimized parameters for a single tank conveyor type dish machine (such as that shown in FIG. 1) may include a wash temperature in the range of 160° F. to 164.5° F., a rinse temperature in the range of 182° F. and 211° F., and/or a rinse flow rate in the range of 0.4 gal/rack and of 0.66 gal/rack. The data of Table 7 further indicates that optimized parameters for a single tank conveyor type dish machine (such as that shown in FIG. 1) may include a wash water temperature of 162° F., a rinse temperature of 187° F., and/or a rinse flow rate of 0.57 gal/rack.

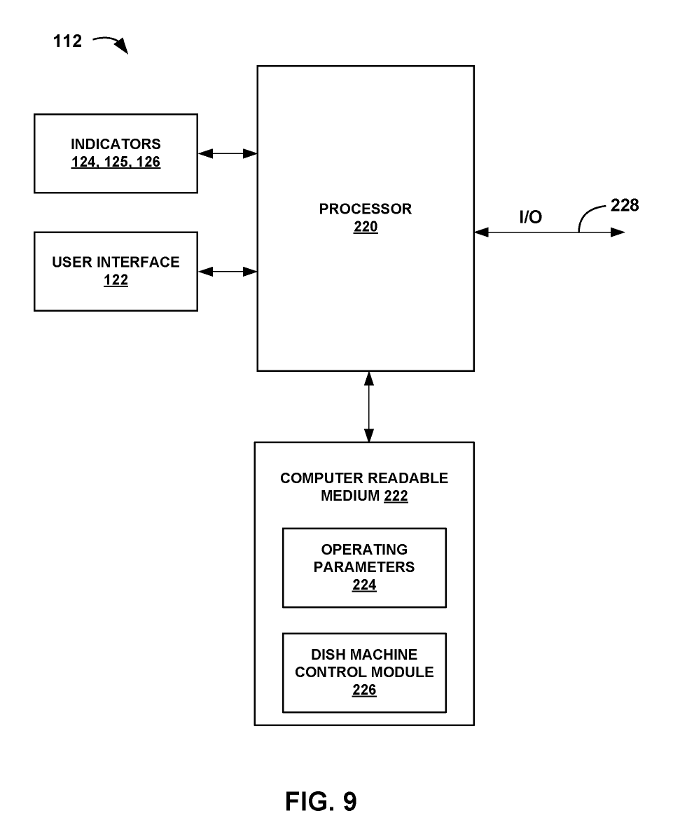

FIG. 9 is a block diagram illustrating an example implementation of the electronic components of a dish machine controller, such as dish machine controller 112 shown in FIG. 1. Dish machine controller 112 includes a processor 220, which further includes a computer readable medium (memory or storage) 222. Computer readable medium 222 includes dish machine operating parameters 224 and a dish machine control module 226. Operating parameters 224 includes parameters associated with operation of the dish machine, including one or more of the optimized operating parameters described herein (wash water temperature, rinse water temperature, and rinse flow rate). Other parameters may also be stored, such as number of wash or rinse cycles, the length of the wash or rinse cycles, times at which chemical products should be applied during the wash or rinse cycles, etc. Dish machine control module 226 includes control software/firmware executed by processor 220 to control operation of the dish machine.

Processor 220 controls operation of the dish machine by opening valves at predetermined times, heating water to predetermined temperatures, applying water to the wash tank at predetermined times and at predetermined wash and/or rinse flow rates, causing chemical product to be dispensed at predetermined times during the wash or rinse cycles, etc. To do so, processor 220 controls the various pumps, valves, chemical dispensers, dish machine arms, and other components of the dish machine via input/output lines, indicated generally by I/O line 228.

User interface 122 may be used to input commands into the controller 112, or to display data, text, or other instructions to a service technician or other user. First, second, and third status indicators 124, 125, and 126, respectively, may indicate the current operational status of the dish machine (e.g., wash phase, rinse phase, final rinse phase, etc.), for example.

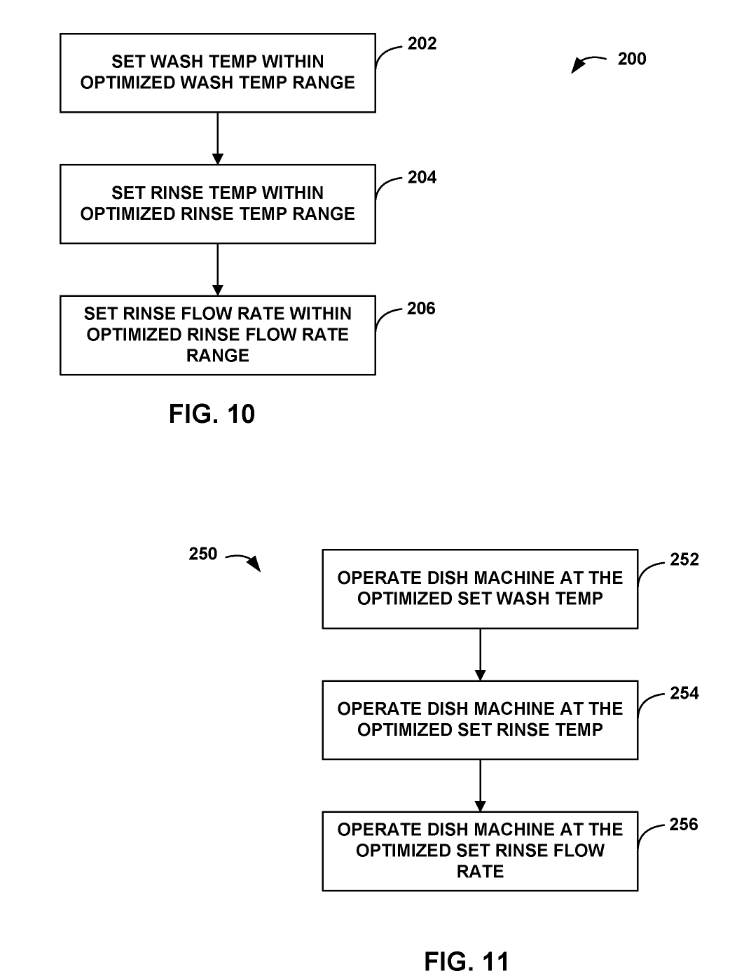

FIG. 10 is a flow diagram illustrating an example process 200 for setting optimized operational parameters of a dish machine. As discussed above, the parameters may be stored in a computer readable medium for access by a processor that controls operation of the dish machine. The parameters may include, in this example, one or more of a wash water temperature, a rinse water temperature, and a rinse flow rate.

In some examples, one or more of the parameters may be set by a service technician via a user interface such as user interface 122 shown in FIGS. 1 and 9. As another example, one or more of the parameters may be set at the time of manufacture. As another example, one or more of the parameters may be set remotely. For example, a service technician or other user may set one or more of the parameters from a remote computer, cell phone, personal digital assistant, tablet computer, or other electronic device. The parameters may be sent via the internet, a local or wide area network, a cell phone network, a satellite network, a telephone line, or other mode of electronic transfer. One or more of the parameters may also be updated from time to time using any of these techniques. It shall therefore be understood that the operating parameters may be programmed into the dish machine controller in many different ways, and that the disclosure is not limited in this respect.

Referring again to FIG. 10, the wash water temperature may be set within the optimized wash water temperature range (220). For example, the wash water temperature may be set within the range of 106° F. to 164.5° F. The rinse temperature may be set within the optimized rinse water temperature range (204). For example, the rinse water temperature may be set within the range of 182° F. to 211° F. The rinse flow rate may be set within the optimized rinse flow rate range (206). For example, the rinse flow rate may be set within the range of 0.4 gal/rack to 0.66 gal/rack. Once the parameters are set, the dish machine is ready for operation.

FIG. 11 is a flow diagram illustrating an example process for operating a dish machine utilizing one or more optimized operational parameters. The dish machine may be operated at the optimized set wash water temperature (252). For example, the dish machine may be operated at an optimized wash water temperature set within the range of 106° F. to 164.5° F. The dish machine may be operated at the optimized set rinse water temperature (254). For example, the dish machine may be operated at an optimized rinse water temperature set within the range of 182° F. to 211° F. The dish machine may further be operated at the set rinse flow rate (256). For example, the dish machine may be operated at an optimized rinse flow rate set within the range of 0.4 gal/rack to 0.66 gal/rack.

In some examples, control of a dish machine may encompass one or more computer-readable media comprising instructions that cause a processor, such as microcontroller 30, to carry out the methods described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, a optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

Control of a dish machine may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above.

Various examples have been described. These and other examples are within the scope of the following claims.

1. A method of operating a dish machine, the method comprising:
storing a wash water temperature of between 160° F. and 164.5° F.;
storing a rinse water temperature of between 182° F. and 211° F.;
storing a rinse flow rate of between 0.4 gal/rack and 0.66 gal/rack; and
operating the dish machine at the stored wash water temperature, the stored rinse water temperature, and the stored rinse flow rate.

2. The method of claim 1, wherein operating the dish machine further includes:
washing articles in a wash tank of the dish machine wherein the stored wash water temperature is approximately 162° F.;
rinsing articles in the wash tank of the dish machine wherein the stored rinse water temperature is approximately 187° F.; and
rinsing articles in a wash tank of the dish machine wherein the stored rinse flow rate is approximately 0.57 gal/rack.

3. The method of claim 1, wherein operating the dish machine further includes:
rinsing articles in the wash tank of the dish machine at a rinse water temperature of approximately 187° F. at a relatively lower food soil concentration; and
rinsing articles in the wash tank of the dish machine at a rinse water temperature of approximately 195° F. at a relatively higher food soil concentration.

4. A method, comprising:
washing articles in a wash tank of a dish machine at a wash water temperature of between 160° F. and 164.5° F.;
rinsing articles in the wash tank of the dish machine at a rinse water temperature of between 182° F. and 211° F.; and
rinsing articles in the wash tank of the dish machine at a rinse flow rate of between 0.4 gal/rack and 0.66 gal/rack.

5. The method of claim 4, wherein washing articles in the wash tank of the dish machine comprises washing articles in the wash tank of the dish machine at a wash water temperature of approximately 162° F.

6. The method of claim 4, wherein rinsing articles in the wash tank of a dish machine comprises rinsing articles in the wash tank of the dish machine at a rinse water temperature of approximately 187° F.

7. The method of claim 4, wherein rinsing articles in the wash tank of a dish machine comprises rinsing articles in the wash tank of the dish machine at a rinse flow rate of approximately 0.57 gal/rack.

8. A dish machine, comprising:
a wash tank sized to receive articles to be washed;
a computer readable medium that stores one or more dish machine operating parameters, wherein the dish machine operating parameters include at least one of a wash water temperature of between 160° F. and 164.5° F., a rinse water temperature of between 182° F. and 211° F., and a rinse flow rate of between 0.4 gal/rack and 0.66 gal/rack; and
a processor that controls operation of the dish machine based on the one or more dish machine operating parameters.

9. The dish machine of claim 8, wherein the processor further controls washing of the articles in the wash tank of the dish machine, wherein the wash water temperature is approximately 162° F., and controls rinsing of the articles in the wash tank of the dish machine, wherein the rinse water temperature is approximately 187° F. and the rinse flow rate is approximately 0.57 gal/rack.

10. The dish machine of claim 8, wherein the dish machine is a single tank conveyer dish machine.

11. The dish machine of claim 8, wherein the dish machine is a high efficiency single tank conveyor dish machine.

12. The dish machine of claim 8, wherein the processor further controls rinsing of the articles in the wash tank of the dish machine at a rinse water temperature of approximately 187° F. at a relatively lower food soil concentration, and controls rinsing of the articles in the wash tank of the dish machine at a rinse water temperature of approximately 195° F. at a relatively higher food soil concentration.

13. An apparatus, comprising:
a wash tank sized to receive articles to be washed during a cleaning process;
a conveyor that moves articles through the wash tank;
a dispense module that applies one or more chemical products into the wash tank at appropriate times during the cleaning process;
one or more wash arms that deliver water and/or one or more of the chemical products into the wash tank during the cleaning process;
a sump positioned to capture and hold liquid drained from the wash tank during the cleaning process;
a computer readable medium that stores one or more dish machine operating parameters, wherein the dish machine operating parameters include at least one of a wash water temperature of between 160° F. and 164.5° F., a rinse water temperature of between 182° F. and 211° F., and a rinse flow rate of between 0.4 gal/rack and 0.66 gal/rack; and
a dish machine controller that monitors and controls the one or more dish machine operating parameters during the cleaning process.

14. The apparatus of claim 13, wherein in response to detecting initiation of a wash phase of the cleaning process, the dish machine controller controls dispensation by the dispense module of one or more chemical products used during the wash phase,
and wherein in response to detecting initiation of a rinse phase of the cleaning process, the dish machine controller controls dispensation of one or more chemical products used during the rinse phase.

15. The apparatus of claim 13, wherein the dish machine controller further controls washing of the articles in the wash tank of the dish machine, and wherein the wash water temperature is approximately 162° F.

16. The apparatus of claim 13, wherein the dish machine controller further controls rinsing of the articles in the wash tank of the dish machine, and wherein the rinse water temperature is approximately 187° F.

17. The apparatus of claim 13, wherein the dish machine controller further controls rinsing of the articles in the wash tank of the dish machine, and wherein the rinse flow rate is approximately 0.57 gal/rack.
